(19) United States
(12) Patent Application Publication
(10) Pub. No.: US 2021/0264686 A1
(43) Pub. Date: Aug. 26, 2021

(54) METHOD IMPLEMENTED BY COMPUTER FOR THE CREATION OF CONTENTS COMPRISING SYNTHESIS IMAGES

(71) Applicant: FAIRYTOOL, Saint-Ouen (FR)

(72) Inventor: Jean-Colas PRUNIER, Thomery (FR)

(73) Assignee: FAIRYTOOL, Saint-Ouen (FR)

(21) Appl. No.: 17/255,551

(22) PCT Filed: Jul. 17, 2019
(86) PCT No.: PCT/FR2019/051796

§ 371 Date: Dec. 23, 2020

(30) Foreign Application Priority Data
Jul. 18, 2018 (FR) FR1856631

(51) Int. Cl. G06T 19/20; G06T 13/20; H04L 29/08

(52) U.S. Cl. CPC G06T 19/20; G06T 2219/024; H04L 67/1095; G06T 13/20

(57) ABSTRACT

The invention relates to a method implemented by computer for the creation in a collaborative manner and in a real-time unified process of animation contents, characterized in that it comprises on the one hand steps of producing and disseminating animation contents as synthesis images intended to be implemented by virtue of the combined action of a plurality of terminals and of a central server, and on the other hand steps of managing these animation contents, said steps being adapted to allow the central server to centralize and manage the set of data produced at the stage of the production steps.

The present invention relates to a method implemented by computer for the creation in a collaborative manner and in a real-time and unified process, also known as pipeline, of digital sound and animated sequences comprising synthesis images.

In the field of audio-visual creation, the term 2D, associated with traditional animation for example performed by a succession of images drawn by hand or by video, is opposed to the term 3D, corresponding to the creation of animated sequences or fixed images whereof the creation is the result of computations generally performed by a computer. This is why the images produced in 3D are qualified as synthesis images.

The 3D animated sequences may be of two types: pre-computed or real-time. In the case of pre-computed sequences, the 3D animations are computed in advance and the contents created are subsequently saved in a video file or in the form of a sequence of digital images. Once computed, the content of the images can no longer be modified. The real-time sequences are computed at the time of the display, generally by dedicated processors known as GPU or graphic cards specially designed to compute synthesis images at very high speed.

It is known in the prior art that a frequency for generating these 2D or 3D animated sequences, pre-computed or real-time, is generally of at least 24 images per second regardless of the size of the image, the number of outputs and the sound quality generated.

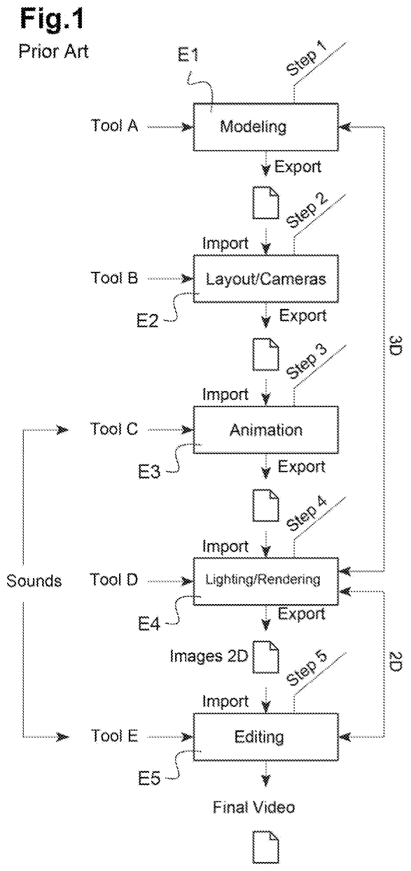

The production of contents as synthesis images responds for the person skilled in the art to a set of distinct tasks whereof the main steps are, in order of usual production, with reference to FIG. 1:
E1. A step of creating 3D models (a human, an animal, an object optionally articulated), step also known as modelling or surfacing.
   The appearance of the model such as the colour of the surface thereof or a matt or shiny aspect for example, is also defined during this step. These models are known as assets.
E2. A so-called layout step. During this step the objects created in the previous step are assembled and arranged to form more complex sets. In other words, “scenes” are set up, within the cinematographic meaning, comprising for example sets and characters positioned to meet the needs of the story and of the aesthetic considerations. A plurality of angle shots are selected to film these virtual sets and the possible 3D characters that are located therein.
E3. A so-called animation step. It consists of animating the elements set up during the layout by means of various methods.
E4. A lighting step. In order to be visible, the elements constituting the scenes from the layout, filmed from the angle shots chosen in the step of the layout, must be lit.
E5. An editing step, during which the various virtual scenes filmed and animated from the various angle shots are placed end to end in order to form what constitutes the film.

A usual method for producing animation content as synthesis images, known as production pipeline, also generally comprises, before the editing step E5, a rendering step, during which texture and special effects are applied to elements of the scenes represented in order to give them a visual aspect that complies with the required artistic criteria.

Other steps exist that we have not described here because they are not strictly necessary for the production of a linear animation content. It can be cited for example the so-called step of effects that makes it possible to create explosion, smoke, liquid, fire effects or to simulate the movement of clothes, etc., the step of the compositing that consists of mixing a plurality of image sources to form only one therefrom, and that of the grading that consists of modifying the balance of colours of an image in order to modify the appearance thereof. Moreover, the production of a linear narrative content as animation is often preceded by the description of this content in a written format (commonly referenced under the term of script or of scenario or screenplay) and of a storyboard, which is a representation of this script in the form of a succession of drawn images.

The set of these work steps constitutes a production method commonly known as production pipeline.

Such a production pipeline is produced in a sequential, linear and fragmented manner. Hence, each step of this pipeline requires computer tools, also known as software solutions, specialized and generally independent from one another; in addition such projects generally involve a large number of people working simultaneously on all of these disparate tools.

Furthermore, the production pipelines known for the production of professional 3D animation projects for pre-computed linear animations, such as an animation film, are not generally adapted to the design of linear real-time animation contents or requiring few interactions for media such as augmented reality or virtual reality.

The process for producing animation contents (which will more generally be referred to as being a 3D animation) is above all a creative process. Such a creative process requires that it is possible by successive iterations to test, preferably rapidly and often, ideas on all aspects of the medium.

For example, producing a linear 3D animation content, requires that it is possible at any time of the creation process, to make modifications to the steps of the modelling, layout, animation, lighting or editing because the results produced at each of these steps have an impact on the final result; in other words on the content produced at the end of the chain.

A feature-length 3D animation project for the cinema for example is the result of tens or even hundreds of thousands of modifications made by all of the people contributing to the production thereof.

Some of these modifications are minor, so-called micro-modifications, such as for example adjustments of small amplitude on the colour of an object, on the length of a drawing in a film editing, or major, so-called macro-modifications, such as for example deciding to modify the appearance of the main character of the story.

Macro-modifications are less frequent than micro-modifications but they are more visible and have a greater impact on the creation process. Yet, with regard to these criteria, the production pipelines of the prior art pose numerous problems of which:
1. Because they are linear, a modification performed upstream of the production chain, requires going through all of the steps that are located downstream of the step where the modification is made, before being able to be considered in the context of the final content (output of the step of the editing). The process is similar to that of a domino or cascade effect: a modification upstream triggers a whole series of events downstream until reaching the last step of the chain.
2. The tools used at the various steps of the production not producing real-time results and not communicating with one another (due to the fragmented nature of the production pipeline), the modifications made cause significant losses of production time. It is not rare that a modification takes a plurality of minutes, a plurality of hours, or even sometimes a plurality of days before it can produce a visible result, in particular depending on position thereof in the production chain.

Also one of the well-known problems is to optimize the process of creating 3D animation contents, mainly linear, regardless of whether they are real-time or pre-computed, in particular by ensuring that a large number people can work simultaneously on the production of these contents.

In order to solve the above-mentioned problems, we propose a real-time and collaborative unified pipeline method implemented by computer for the creation in a collaborative manner, of animation contents, characterized in that it comprises on the one hand steps of producing and disseminating animation contents as synthesis images intended to be implemented by a plurality of terminals in cooperation with a central server, and on the other hand steps of managing these animation contents adapted to allow the central server to centralize and manage the set of data produced at the stage of the production steps;
said steps of producing said real-time unified method comprising:
   a step of creating an animation content project;
   a step of creating one or more 3D scenes and one or more 3D sequences in said project created;
   a step of opening and editing at least one 3D scene;
   a step of opening and editing at least one 3D sequence created to assemble said content as synthesis images;
   steps of disseminating the animation content;
said management steps comprising:
   a step of managing a production history, adapted to provide the transmission and the recording of the result of the implementation of production steps by a terminal to the central server;
   a step of updating the project stored on said server depending on said results of the implementation of production steps by a terminal transmitted during the step of managing the production history;
   a step of detecting conflicts adapted to be implemented on the server so as to detect when at least two production steps have created, modified or deleted, directly or via another related data, simultaneously at least one same data stored on the central server;
   a step of resolving conflicts, when a conflict is detected in the previous step, capable of determining the creation(s), modification(s) or deletion(s) to apply to said at least one data for which a conflict is detected.

Thus, a simple, unified, collaborative and connected method is obtained capable of managing within the same application the creation and the dissemination of animation contents comprising synthesis images, adapted to pre-computed or real-time renderings.

Advantageously and in a non-limiting way, the method comprises a step of real-time synchronization of the project between the central server and said terminals so that each terminal implementing the steps of producing the method receive all or part of the data of the project up to date depending on all of the modifications and creations made by the set of terminals and of the server, said synchronization step being adapted to be implemented by the server during an operation in collaborative work mode and/or by said terminals when same connect to the server. Thus, it can be ensured that any user person working from a remote terminal of the server continuously possesses the latest version of the current project of content, and this even when a large number of users work simultaneously on the project.

Advantageously and in a non-limiting way, the method comprises for said steps of updating and of synchronizing the project between the central server and said terminals a plurality of data synchronization modules, said plurality of modules comprising:
a real-time update module adapted to implement a cryptographic encoding function generating a hash key depending on said data of the project, said real-time update module being adapted to determine if the data of the project imported must be recorded by said terminals and the server;
a real-time optimization module capable of detecting changes in transient state of the data of the project, and being adapted to compress said list of the creation history of projects so as to reduce the amount of data transferred and stored by said terminals and the server;
a real-time control module using said hash key so as to control the integrity of the data transmitted between said terminals and the server,
a real-time learning module, capable of analyzing the data of the creation history of projects, and of defining an order of priority, according to which said server transmits and updates, the data to said terminals;
a real-time versioning module, capable of preserving the creation history of projects in the form of a series of total state backups of the project and of intermediate revisions relative to these states; said frequency of the backups of the total states depending on learning data of said real-time learning module;
a real-time marking module capable of authorizing a user of a terminal to mark by at least one tag a key step of the development of the project, said marking module making it possible to restore said project to the state thereof at the moment of marking.

Thus, the update and synchronization steps are reliable, robust and rapid.

Advantageously and in a non-limiting way, the method further comprises access management steps for prohibiting or authorizing the implementation of all or part of the production and management steps to a terminal connected to the server. Thus, the rights for implementing the method can be segmented in order to limit the interactions during collaborative work involving numerous people. Furthermore, the access control makes it possible to limit the risks of accidental modification or deletion of content for example.

Advantageously and in a non-limiting way, the step of resolving conflicts comprises the exclusion from the project of a first result of the implementation of production steps by a first terminal, when a second result of the implementation of production steps by a second terminal has generated the detection of a conflict, the earlier event being excluded if one of the following criteria is met:
the first result deletes an object that has been deleted, modified, added or referenced by the second result;
the first result adds an object that has been deleted, added or modified by the second result;
the first result modifies a property of an object that has been deleted by the second result;
the first result modifies a single property of an object that has also been modified by the second result;
the first result adds a reference to an object that has been deleted by the second result;
the first result adds a reference to an object or a value for a property of an object that may have a plurality of values, which has been added, deleted or changed by the second result;
the first result deletes a reference to an object or a value of an object that may receive a plurality of values for the same property having been added, deleted or changed by the second result;
the first result moves a reference to an object or a value of a property that may receive a plurality of values having been added, deleted or moved in the same property by the second result.

Advantageously and in a non-limiting way, the method comprises an automatic learning module adapted to optimize the sequence for loading data into the memory of said terminals in order to reproduce as sound and animated images the content of the project in real time on said terminals, depending on the data of the creation history of the project, data of the project and metadata generated by said terminals. Thus, the bandwidth used between the terminals and the server can be optimized as well as the memory occupied and the computation time necessary on the terminal side and on the server side.

Advantageously and in a non-limiting way, said steps of producing and disseminating the animation content, comprise a step of real-time display of said animation content on an augmented reality device, such as a smartphone or a tablet, connected to said server.

Particularly, the method implements a step of creating a virtual camera suitable for an augmented reality device, said step of creating a virtual camera being implemented after said step of opening and editing at least one 3D scene.

The invention also relates to a server device comprising a network interface, a storage memory and a processor for implementing at least the steps of managing and/or the steps of producing and disseminating the animation content of the method such as previously described.

The invention also relates to an augmented reality assembly, comprising a server device such as previously described and an augmented reality device, such as a smartphone or a tablet, said server device implementing the steps of producing and disseminating the animation content of the method such as previously described.

The invention also relates to a computer terminal for controlling a human-machine interface adapted to execute and/or perform at least the steps of producing the method previously described, and comprising a network interface for communicating with said server device previously described.

The invention also relates to a computer system comprising a server device such as previously described and one or more computer terminals such as previously described.

The invention also relates to a storage medium readable by a computer, for example a hard drive, a mass storage medium, an optical disk, or any other suitable means, having recorded thereon instructions that control a server device and/or a computer terminal in order to execute a method such as previously described.

Other specific features and advantages of the invention will become apparent upon reading the following description of a specific embodiment of the invention, given by way of illustrative but non-limiting example, with reference to the appended drawings wherein:

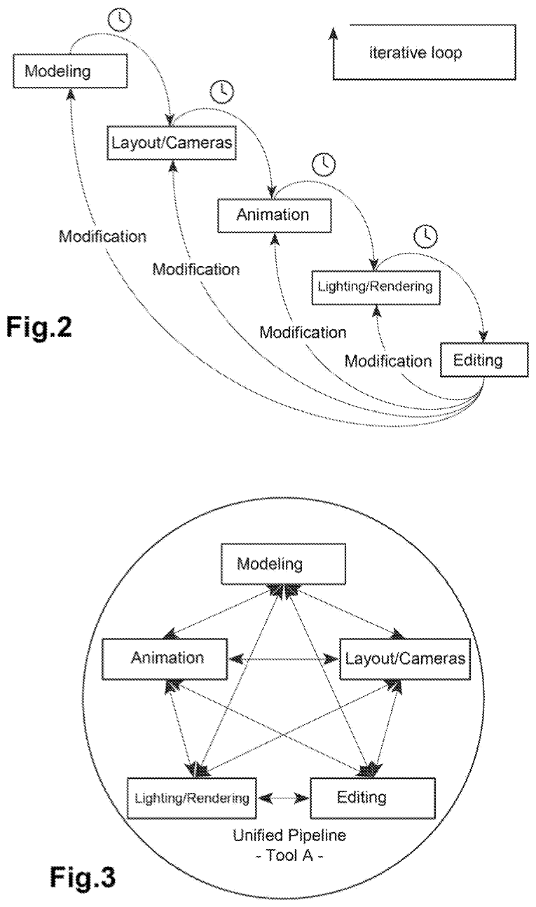

FIGS. 1 and 2 are schematic views of a production pipeline of the prior art;

FIG. 3 is a schematic view of interactions between production steps of a method according to one embodiment of the invention;

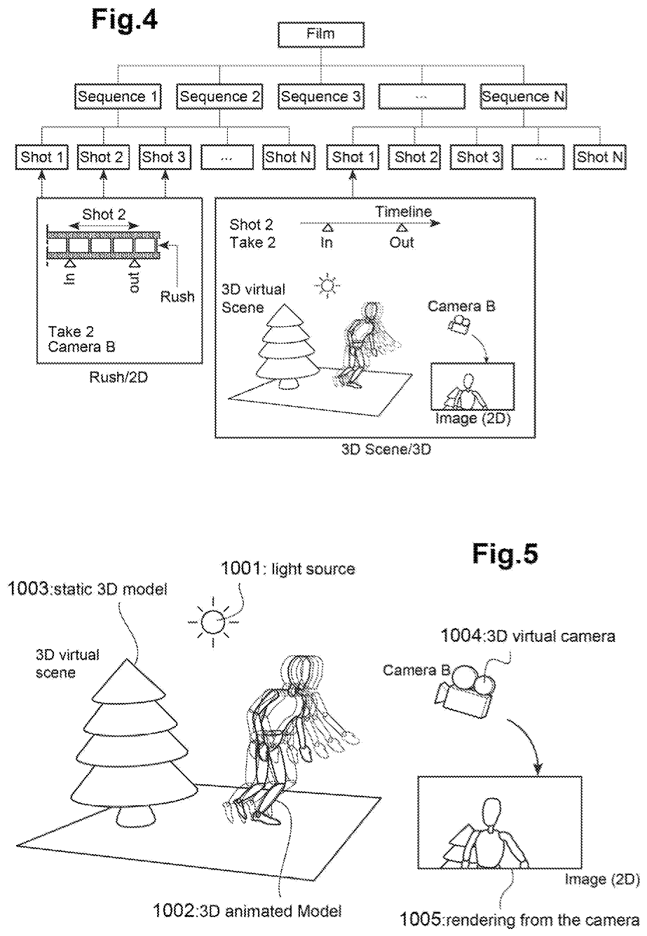

FIG. 4 is a graphic representation of a project of animation content as synthesis images;

FIG. 5 is a representation of a 3D scene known from the prior art shown in the more conventional form thereof by a series of objects or 3D models, known as assets, each comprising properties for modifying the appearance thereof;

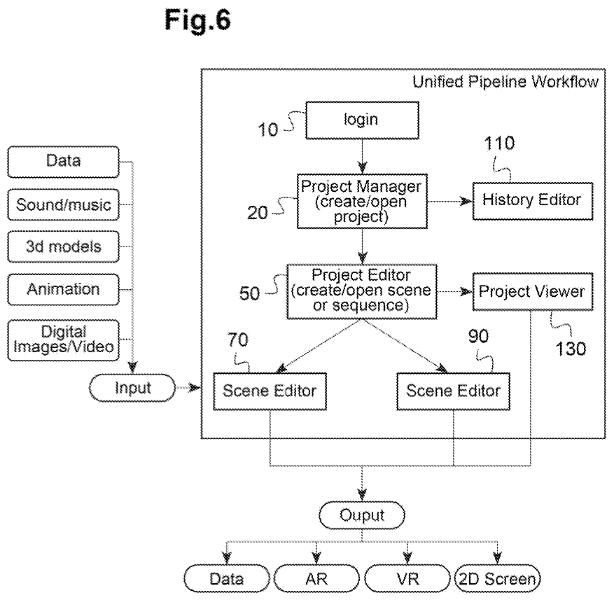

FIG. 6 is a schematic view of the organization of the data of a content project of a method according to one embodiment of the invention;

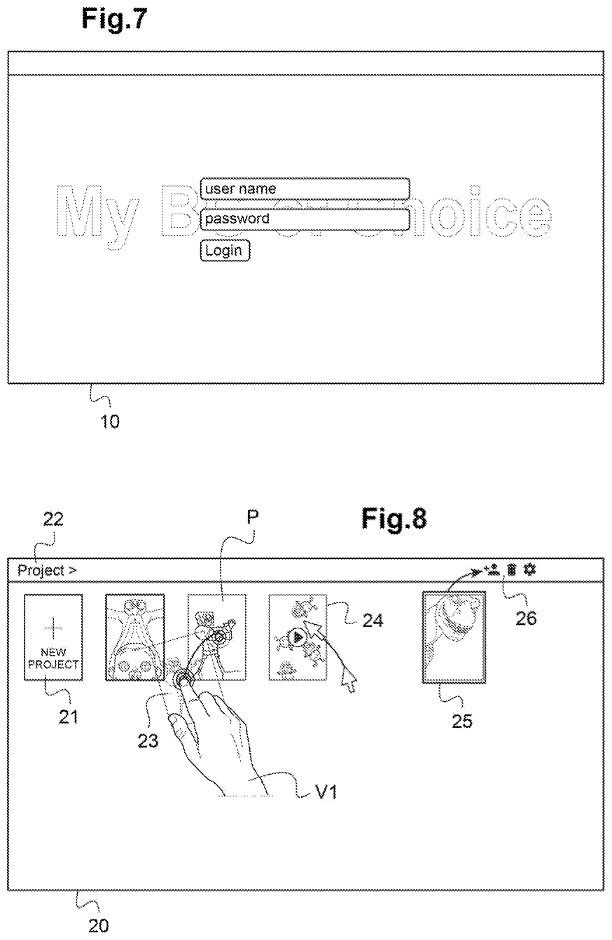

FIGS. 7 to 16 are simplified views of user interfaces of the implementation of the method on a computer according to one embodiment of the invention;

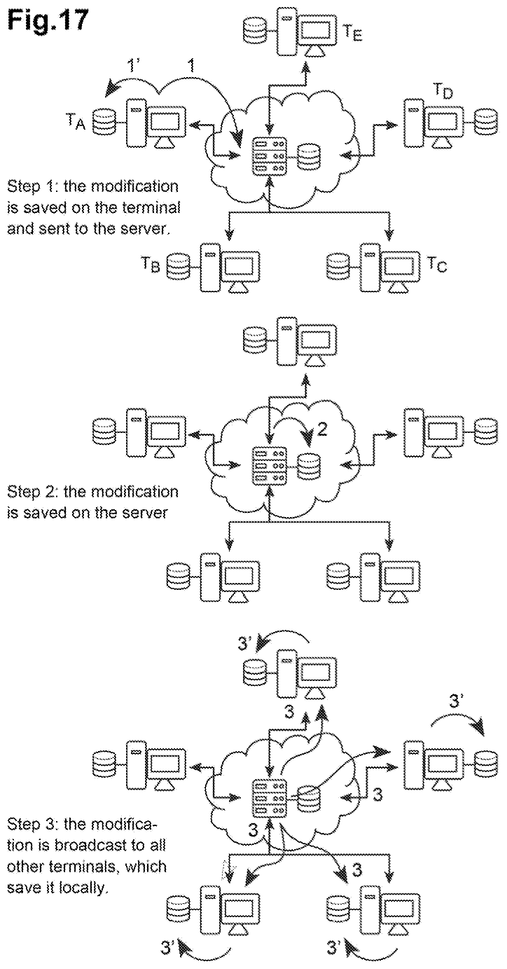

FIG. 17 is a schematic view of a synchronization step according to one embodiment of the invention;

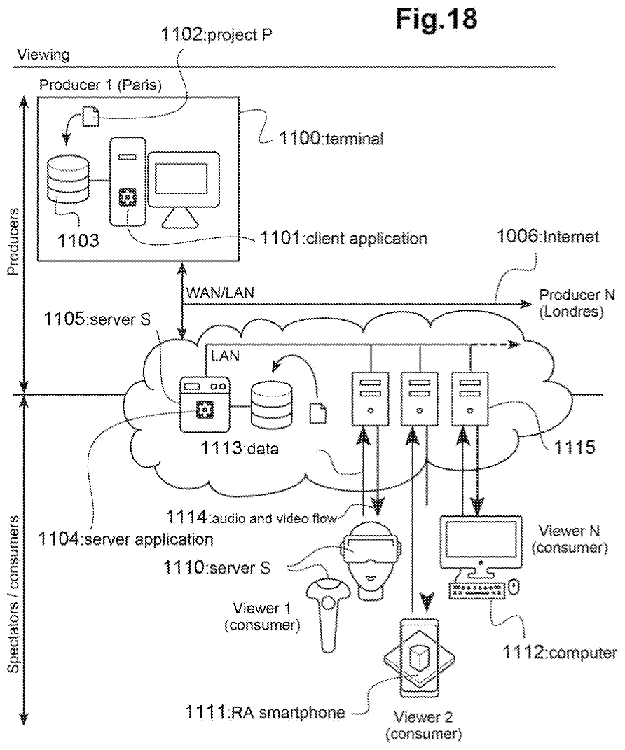

FIG. 18 is a schematic view of a group of dissemination and distribution steps according to one embodiment of the method;

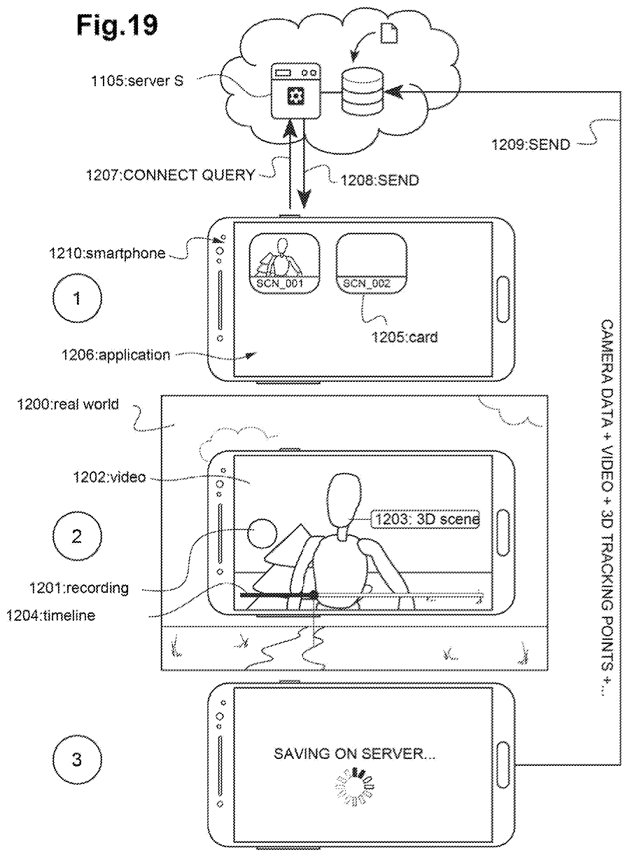

FIG. 19 is a schematic view of a group of dissemination and distribution steps according to another embodiment of the method.

The invention relates to the design of a method dedicated to the creation, the production, the distribution and the dissemination of linear animation contents or more generally the creation and the distribution of sound and animated sequences by using a variety of sound and graphic sources that may be combined together such as for example, synthesis images, also known as 3D content, mainly, but also digital images and videos, known as 2D content, in a process, or pipeline, that is both unified, real time, collaborative and connected to other methods for creating real-time animation contents, in particular for augmented reality.

The sound and animated sequences generated by this invention may be either pre-computed and saved in video files for example, or computed on the fly which makes it possible to use same on augmented or virtual reality type systems or any other existing or future display or dissemination system (such as for example streaming) for which sound and animated sequences as synthesis images must be computed on the fly, in real-time (real-time 3D display).

The method implemented by computer according to the invention comprises a plurality of production steps leading to the manufacturing of contents, able to be implemented at the same time as and independently of one another.

The method according to the invention is also known as Collaborative Unified Pipeline to which we will make reference in the remainder of this document using the acronym CUP.

In the remainder of the description, reference will be made to the user of the method as any person, or group of people, acting on the method implemented by computer according to the invention, by means of a computer or of any device capable of communicating with the computer implementing all or part of the method.

The various production steps, that may also be called functions, are described firstly separately from one another, then presented within the scope of a detailed embodiment.

The method according to the invention comprises two main groups of production steps: creation and edition steps and dissemination steps.

The first group of production steps is generally implemented on the user terminals, whereas the second group of steps is in this embodiment implemented on the server.

The method further comprises a third group of steps known as management steps, these steps being conjointly implemented by the terminals and the server, these steps comprising in particular the history and conflict resolution steps, which will be described further.

The first group of production steps known as creation and edition functions comprises the set of steps E1-E5 of the production of a 3D animation content, with reference to FIG. 1, from the modelling step E1 to the final step of the editing E5 such as we have described same in the prior art.

Also, the method according to the invention implemented by computer makes it possible to create a real-time 3D animation content from the start to the end, said first group of steps comprising five steps of:
1. Creating or opening an animation content project;
2. Creating new 3D scenes that may however contain a diversity of other sources (such as digital images, videos, etc.), and creating new sequences;
3. Opening and editing 3D scenes created in the previous step. In this step the user of the method may model on the spot or import 3D models created with other solutions, choose angle shots (by means of virtual cameras that are placed in the scene), add lights, and animate all of the objects of the scene (the models, the cameras, the light sources, etc.) and all of the properties of these objects (such as for example the colour of a 3D object). A scene may also contain a plurality of versions of the animation (or animation take in the terminology of the person skilled in the art);
4. Opening and editing sequences created in step 1.2. In this step, the user of the method may edit the content of a sequence. The process involves placing a set of drawings end to end as in a video editing solution. Unlike video editing software packages, the invention uses by way of drawings not videos but the 3D scenes created in the previous step 1.3. For each scene used in the editing of the sequence, the user must as a minimum specify the camera or the angle shot wherefrom said scene will be computed.
   However, as for any editing tool, the order and the length of the drawings that constitute the editing may also be changed. In short, a drawing in this system is defined as a minimum by a 3D scene, the version of the animation that must be used for this scene when same is played, an angle shot wherefrom this scene is filmed when same is played in the editing, and the usual editing information such as the position of the drawing in the editing, the duration thereof, and the point of input and of output thereof.
   4.1. It is possible to create a sequence from a linking of drawings using a single and the same 3D scene filmed from different angle shots.
   4.2. It is also possible to use a plurality of 3D scenes in the same sequence. The possibility of mixing various scenes in one and the same sequence is a feature of the invention;
5. Playing the content by playing the sequences created and edited in the previous step 4.
   5.1. In a first embodiment of the invention, the content of the project is computed in 2D in order to be projected on the screen of the computer on which the system is executed (this may also concern the screen of a tablet or of a smartphone or any projection device connected to the computer).
   5.2. In a second embodiment of the invention, not exclusive of the first, these contents are computed in order to be disseminated on augmented and virtual reality systems.
   5.3. In a third embodiment of the invention that is described in detail in the remainder of the document, the content may be computed on the fly on one or more processors and the result, the video and audio output, disseminated (or streamed according to a neologism frequently used by the person skilled in the art) towards another electronic/computer device.

It should be noted that the scenes, the sequences, and the finalized content consisting of the set of sequences, are played in real time and may be computed as we have just indicated in order to adapt to the constraints of any display system whether same is a screen of a computer, smartphone or tablet, an augmented or virtual reality system, or any other suitable device.

As this concerns 3D scenes filmed from an angle shot chosen by the user of the system, same are computed on the fly. The fact that the images are not pre-computed as in the case of videos is a key element of the invention, since this makes it possible for the user of the system to modify any element of the project at any step of manufacturing and disseminating the content, for example the position of an object in a scene, the position of a camera, the position and the intensity of a light source, the animation of a character, the editing of a sequence, by using any display system and to be able to see the result of their changes in real time.

All of these steps may be executed exclusively by the method implemented by computer according to the invention which, associated with a system of succession of display of human-machine interface screens, makes it possible for the user to go from one step to another smoothly.

In other words, this navigation or screen system has been designed to bring together the set of steps of manufacturing a 3D animation content in one and the same method, in other words in one and the same solution, in order to make it possible for the user to work on any aspect of the film (the layout, the editing, the lighting, the animation, etc.) at the same time and with a real-time feedback (next point).

Indeed, the method according to the invention is a real-time method. For this, the method is based on two elements:

The solution of the unified pipeline described above (1) takes advantage of the capacities of graphics processing units (GPU) that have been designed to accelerate tasks such as the computation of synthesis images or the computation of deformations of animated 3D objects whereof the computer processing lends itself well to massively parallel type computing architectures. The use of graphics processing units (GPU) does not exclude in the solution the use of central processing units (CPU). The computer processing resources required by the solution are much more superior than those required by a software solution designed for editing text (the solution enters in the category named data-intensive computing). Therefore, it is preferable to be able to use all of the available resources of the computer/electronic device whereon the solution is executed, which involves combining the computing capacities of the CPU(s) and GPU(s) available on the computer device where the solution is implemented.

The method according to the invention is adapted so as to make possible a collaborative implementation operation.

To this end, the method according to the invention makes it possible for a plurality of users to work at the same time on the same 3D animation content/project/film and to see in real time the changes performed by all of these users.

The method therefore makes it possible to simultaneously carry out collaborative work remotely.

Also, the method is partially implemented on a server that centralizes the data, whereas another part of the method is implemented on terminals, for example desktop computers, tablets or smartphones. The centralized part of the method being common for the implementation of the method by the set of terminals of the same 3D animation content project.

In a preferred version of the invention, the users have access to the data of the project by virtue of a software solution (hereafter named client application) executed on their terminal, in other words on their computer device of which the user uses to work.

The terminal is a complete computer processing unit that disposes of one or more central and graphics processing units as well as of one or more audio and video output devices that make it possible to display images and play sounds on a variety of devices (computer screen, virtual reality headset, loudspeaker, headphones, etc.).

Upon starting the application, the computer program (client application) executed on the terminal, connects to a remote application (hereafter named server application), which is itself executed on the server of the network to which the terminal is connected (hereafter named server S).

In order to allow the server and client applications to process the data that same send and that same receive, the data of the project are encapsulated according to a protocol specific to the invention.

For the transit of encapsulated data on the network, any standard protocol may be used (such as for example TCP/IP that is the protocol used for data exchanges on the Internet). In a preferred version of the invention, the terminal and the server form a Local Area Network (LAN).

In another version of the invention, the terminal and the server belong to different networks but may nevertheless communicate by virtue of an Internet-type connection for example. In this case, same form a Wide Area Network (WAN).

A work session is created from the moment when at least one client is connected to the server; the number of client applications connecting to the server in a work session has no upper limit.

This division makes it possible for the client application C₁ to send to the server application all of the modifications made to a project P from the terminal T₁.

When same receives a modification, the server S application executes two tasks: 1) same applies this modification to its own version of the project 2) same disseminates this modification to all of the clients with which same shares a connection C₂, C₃, . . . , C_{N} with the exception of the client wherefrom the modification comes, which makes it possible for these client applications to apply same to their own version of the project.

All of the versions of the project, whether same maintained by the various client applications C₁, C₂, C₃, . . . , C_{N} or same maintained by the server S application are then up to date or synchronized.

All of the users of the method that are remote from one another and work on different terminals therefore continuously have the same “view” on the project P.

In the present description, client application means the set of steps of the method implemented on the terminal of the user, as opposed to the server application, corresponding to the steps implemented on the central server S.

In this version of the invention, there are as many copies (local) of the project P as terminals, in addition to the copy of the project that is located on the server; in a work session, all of these copies are identical.

When a new client application is launched and when the version of the project P_{c} that is located on the drive of the terminal is not the same as the version Pₛ that is located on the server, the server application then carries out a synchronization step, during which same sends to the client application all of the modifications necessary for updating the project Pₛ so that at the end of the process, the project P_{c} is identical to Pₛ.

The method implemented further comprises a history function, a connected function and distribution functions.

The history function is implemented so that all of the modifications made to the project, by all of the users acting on their remote terminals, simultaneously or not, from the creation thereof are saved on the server S, because whenever a user carries out a modification, whether this concerns a minor or major change, this modification is sent to the server that records same locally before same disseminates same in turn according to the method that has just been explained. The user of the method therefore does not technically need to record the modifications made to preserve their changes.

The data of the history of changes of a project are saved in the memory of the server application but also on the storage space, for example in a hard drive, that is associated therewith.

The data of the history may be divided into two large categories.

The first type of data is represented by all of the assets imported or created in the project by the users. An asset being a term well known by the person skilled in the art and in particular comprising 3D models, images or textures, sounds, videos, materials, etc.

In the method according to the invention, these data are described as blobs (acronym for Binary Large Objects) that may range from a few kilobytes to more than a thousand megabytes (gigabyte).

These blobs are stored on the storage space of the server in the form of binary data.

The second type of data is represented by objects to which properties are attached.

An object is defined as a set of key-value pairs known as property. Each property contains either a value, or a reference (to a blob or another object), or multivalued (list of values or references).

Thus, for example, an object of “3D object” type references a blob containing the meshing information of a 3D model and properties such as the position of this object in a 3D scene, as well as references to the materials that are assigned thereto. A material is another example of object that contains information on the appearance of a 3D model such as the colour thereof or the shininess thereof, each of these properties being able to contain either a constant value or a reference to texture-type blobs.

The amount of memory necessary for the storage of this type of information on the drive of the server is relatively insignificant in comparison with the size of the blobs.

These two types of data differ by the size thereof but also by the editing frequency thereof. The blob-type data are more rarely added to the project than the data of the second type whereof the edition is conversely much more frequent. Changing the colour of an object for example may be carried out in a real-time iterative process, generating tens or even hundreds of changes per second. These data may be seen as representing the creation history of the project.

For example, here is a possible sequence of change of this type:
1. Create a new scene
2. Rename the scene as “SCN_1”
3. Add an imported 3D object into SCN_1
4. Change the position of this object
5. Change the colour of this object (red)
6. Change the colour of this object (green)
7. Change the colour of this object (blue)
8. Add a colour texture to this object.

At this stage of the creation of the project, the project therefore consists of an edition history comprising the steps 1-8 and two blobs saved both on the hard drive of the server but also on same of the client application in what we call in the invention a blob store.

By virtue of this information, it is possible for example to update the project of a second user U2 connecting to the server after the changes performed by U1 have been recorded.

By applying the edition tasks of the history on the project of the second user U2, their project may be updated. For example:
1. A new scene is created in the local copy of the project of U2,
2. This scene is renamed SCN_1
3. The 3D object is imported from the blob store of the server, saved in the blob store of the client application and added to the scene.
4. The position of the object is changed,
5. The colour of the object is changed (red),
6. The colour of the objected is changed (green),
7. The colour of the object is changed (blue),
8. The texture is imported from the blob store of the server, saved in the blob store of the client application and added to the scene.

The method according to the invention comprises modules adapted to the collaborative function and to the generation of the history of the resulting solution. These modules are the following:

management of updates: it can be distinguished 1) the updates within the scope of a real-time collaborative work session (that is to say when a plurality of client applications are already connected to the server) and 2) updates performed when an application connects to the server after a disconnection time:
1. The changes originating from a client application are sent to the server application that saves same locally (in a process described below) then sends same back to the other connected client applications that then execute these changes locally. We are in a “push” logic: the server pushes the changes.
2. When a client application connects to the server after a disconnection time (or for the first time), same obtains from the server a state of the project (via a module described below) that makes it possible for same to establish the list of all of the blobs having been added to this project since the last connection thereof. The client application is then able to establish the missing blobs by comparing this list with the list of blobs already present in the local blob store thereof. Only the missing blobs are thus sent back by the server application to the client application. We are in a “pull” logic: it is the client that requests the list of data that they need in order to be up to date.

management of blobs: when binary type data are added to the project, sometimes a user may add same a plurality of times in a row. Indeed, the binary data are sometimes associated in the form of bundles.

By way of example, a bundle B1 comprising meshing information describing a 3D model and three textures (T1, T2 and T3). In a subsequent work step, the user may import into the project a new version of the bundle B1 that we will call B2.

In this new bundle B2, only the texture T3 is different from the files contained in the bundle B1. Therefore, it is relatively ineffective to re-import into the project the meshing information of the 3D object as well as the textures T1 and T2, only T3 having to be subjected to an update. The storage space and the use of the bandwidth necessary for transferring the binary information to the server, then from the server to the client applications being expensive and limited, it is necessary to only transit and store the new data.

Therefore, the method according to the invention comprises a module for computing a unique signature based on the information that the blob contains. In the main embodiment of the invention, we use a sha type key or hash value, that is to say a key obtained by a cryptographic hash function that generates an imprint unique to each blob of the project.

The function that generates this hash value uses as input the binary data of the blobs.

When the sha for a blob is computed, the method compares the hash value obtained with same of each of the blobs contained in the blob store:
If the method finds a sha in the blob store with the same key, same deduces therefrom that the blob already exists in the project, and that therefore it is not necessary to import same.
If the sha does not yet exist, then the blob is imported.

According to certain embodiments of the invention, the capacity of the storage and of Internet traffic on the server side are limited. Therefore, the user must make good use of this storage capacity and bandwidth and the system must consequently inform them of the impact that an import operation may have on the use of the quota of drive space and traffic that is reserved therefor.

Thus, according to a specific embodiment of the method according to the invention, when the user imports blobs into the project, the client application proceeds so that:
1. All of the blobs contained in a bundle (the imported bundle) are read in memory and a hash value is computed for each blob of the bundle. If the blob exists in the blob store, same is ignored. If the blob does not exist, the size thereof is added to the total size of the data that the user wants to import.
2. Once all of the blobs of a bundle have been analyzed according to the process described above, the total size of the data to be imported into the project and therefore to be stored on the server is obtained. This figure may thus be presented to the user through a user interface. If the user realizes that the amount of data to be imported exceeds the remaining storage capacity on the server or that same is too big (due to a handling error for example) they may decide to cancel the import process or increase the storage size on the server. In the opposite case, they may confirm the import. If the import is confirmed by the user, the data are then transferred to the server and then become accessible to other users of the project.

This two-step import module has been created in the context of the development of the collaborative functions of the method according to the invention and is specific thereto.

management of the creation history: in the example given above, a plurality of steps of the history represent successive and potentially very rapid, for example in the order of a few milliseconds, modifications of a property of the project or of the client application.

For example, in the steps of the project U2 previously disclosed, steps 5, 6 and 7, the three consecutive changes performed on the colour of an object, are very rapid. When modifications are made rapidly on a property of an object, the intention of the user is to go from the state E₀ wherein this property is found before same is changed, to the state E₁ to the state 5, then to the state E₂ in step 6, then finally to state E₃ in step 7.

These modifications being performed in real time (same only require a few milliseconds in order to be executed), same only appear to the user as a continuous succession, or a constant flow of changes. The user stops the iterative process at the state E₃. Therefore, it is possible to consider that the intention of the user is to go from E₀ to E₃ and that the states E₁ and E₂ are only intermediate states known as transient states, wherethrough the user goes before stopping on the final state desired (E₃). A state is said to be transient when the lifetime thereof is very short (a few milliseconds only). The method implements the steps of:
Sending real-time revisions by the server to the client applications in a collaborative edition session: when a user U1 moves an object in a scene S1, and when another user U2 edits the content of the same scene S1 at the same time, U2 sees the object move as same moves in the scene of the user U1. This is possible because all of the revisions whether they are transient or not are sent to the server that sends same back without waiting for all of the client applications to edit the content of the project.
Saving revisions in the creation history of the project: when the user stops modifying a property of the system (which occurs when the following modification concerns another property of the system or when the property concerned stops being modified during a given time), the server application compresses the list of revisions to delete therefrom the transient states and replace same with a revision changing the property of the state E₀ directly to the state E₃, according to our example, and it is the result of this compression that is saved in the creation history of the project. In general terms, when a property of the system goes from a state E_{N} to a state E_{N+P} where P is the number of transient states, the part of the method in charge of managing the history does not preserve in the history the P transient states but a single modification for going from the state E_{N} to the state E_{N+P} directly. This compression method may be implemented by the method according to the invention, either by the client application or on the server application.

management by the server application of corrupted blobs: sometimes certain blobs transmitted by the network from the client applications to the server may only arrive at the server partially or modified. The reasons for which a blob may be corrupted are multiple: the client application that sends the data stops unexpectedly, Internet interruption, computer attack, etc. In order to remedy this problem, the method implements the following steps:
Step 1: the client application computes the hash value H_{B} of a blob B and sends a query to the server application notifying same that same is preparing to send thereto a blob with a hash value H_{B}. Immediately after, the client application starts to send the data to the blob B in relation with this query.
Step 2: when the server stops receiving the data associated with the blob B, same considers that all of the data have been transmitted. Same then computes the hash value of the blob on the server side H′_{B} by using the same algorithm as same used by the client application. If the hash value H′_{B} is equal to same sent by the client application (H_{B}), the server has the guarantee that the data of the blob B are complete and integrated and the process stops at this step. If the value is different, the server goes to step 3.
Step 3: from the moment that the server application re-establishes a connection with the client application, same sends thereto a query asking same to send the data for the blob whereof the data are incomplete.
The server application sends the same query to all of the client applications sharing the same project, in the hypothesis where one of the client applications would be in possession of the same blob and where the client application that has sent the blob initially, would be unavailable. The server application repeats step 3 until same obtains a complete copy of the data of the blob. Moreover, the server does not send the data relating to the blob B to the other client applications while the copy saved on the server side is not complete.

This module that takes the hash value used for the management of the blob store, is important because same guarantees the reliability of the collaborative function of the method according to the invention. Moreover, the previous case describes the module when the data transit from the client application to the server application, but the same module is used when data are transmitted (in the case of an update for example) from the server application to any client application.

“Priorization” of blobs: according to one embodiment of the method according to the invention, the blobs are transmitted from the server application to the client applications depending on the criteria determined by the client applications. A plurality of scenarios may occur:
The bandwidth of the application is not used much: in this case, the blobs are sent by the server application to the client application in the order where the blobs arrived on the server therefore without “Policy” or particular strategy.
After a few hours or a few days of work on a project, it is not rare that the state of the project has change considerably. A user who reconnects to the project after a long period of absence must wait for all of the new blobs of the project to be transferred from the server on their terminal before being able to resume the work. However, it is rare that the user needs to access all of the new blobs after opening the session. The method uses this observation in the following way: the client application detects the part of the project whereon the user works first such as for example a particular scene of the project and transmits this information to the server application that will send the blobs contained in this scene before the others. This hierarchization or prioritization process sends “useful” information first to the user which makes it possible to reduce the waiting time and improve their experience. It is particularly useful for the client applications whereof the bandwidth and the storage space are limited such as for example the augmented reality client application on a mobile phone. In the example mentioned above the metrics used for determining the order of the blobs to send in priority by the server to the client is simple (it is based on the part of the project whereon the user is working) but it may take much more complex forms in particular when it is based on a learning process. Indeed according to one embodiment of the method according to the invention, and consequently of the collaborative function of the invention, the server application is able to know and therefore learn based on the creation history of the project the work habits of each user working on the project, and generally the involvement of each user of the system in various projects. This machine learning-based learning process provides a decision matrix making it possible for the server application to adopt in real time a strategy for the hierarchization of the delivery of blobs the most suitable possible for each user and for each client application. Therefore, the server application maintains a list of priorities for sending blobs by user for each client application (desktop computer, augmented reality application on smartphone, etc.). If the result of the machine learning-based learning process indicates for example that a user works more particularly on one of the assets of the project rather than another, all of the data in relation with this asset will be their priority in the list for sending augmented blobs. When the priorities of all of the blobs waiting on the server for a particular client application have been updated, then the server sends same to the client application in the decreasing order of priority. This process operates in real time (the priorities for each client application and each user of the system are continuously updated) and the list of priorities may change during the sending of blobs (due to new information communicated to the server by the client).
Module for storing intermediate states (tag/snapshot) and the creation history: when a user launches a client application and loads the data of a project that has been subjected to modifications since their last connection, the server application determines, by comparing the creation history thereof with same of the client application, the state E_{c} wherein the project is located on the client application. From the state Eₛ wherein the project is found on the server (with Eₛ>=à Ec), same then deduces therefrom the section of the history H having to be executed on the client application in order to update the project. In other words: H=Es−Ec. However, this module becomes ineffective as the creation history of the project grows.
By way of example, a group of users works on a project for a relatively long period, for example a plurality of weeks or a plurality of months. The project is complex: the history comprises tens or even hundreds of thousands of state changes known as revisions and the blob store comprises a plurality of tens of gigabytes of data. In the case where a user U joins the project, according to the logic described above, the server must send all of the blobs (including same that are no longer potentially used in the most recent version of the project) and the entire content of the history of the project to the new user; in order to install the project on the system of the user in the state Es, all of the revisions since the creation of the project will then be executed on the client application, which may take a lot of time for a project with a significant history as is the case in our example. According to one embodiment of the method according to the invention, the server application automatically and regularly saves a total state of the project. This total state may be seen as a snapshot of the project at time t. The fact that a backup of the total state of the project exists at time t is also preserved in the creation history of the project. By virtue of this method, the server no longer has to send to the new user U, the data relating to the last backup of the total state of the project E_{Total} then all of the modifications performed on the project from the moment when E_{Total} was generated. In the history of the project, the modifications performed to a property of the project are always defined in the creation history, as relative to the state wherein this property is found in the last backup of the total state of the project. The server carries out the total backup of the project when the number of revisions since the last backup of the total state exceeds the value Q_{R} defined by the system.
Management of the history by the user on the client side: by virtue of the module described above, a series of so-called total state backups (images of the project taken at more or less regular intervals) exists on the server. According to one embodiment of the method according to the invention, this series of total state backups of the project and the history of the modifications performed between each total state backup is disclosed in the user interface of the client application in the form of a timeline representing the entire history of the project since the creation thereof. By moving along this line, the user can make sure that the project is restored in an earlier state. For this, the same module as same previously described is used. The server application sends the information for updating the client application by using the backup of the total state of the project T_{Total} the most immediately prior to the desired restore time T_{Restore}, then sends the additional modifications from the time when this backup was performed until the desired restore time (T_{Restore}). The project is then restored in the state where it was at the time T_{Restore}. Through the same user interface, the user can leave in the creation history tags making it possible for them to mark in the creation history of the project the steps considered as key for the development thereof. These tags make it possible to rapidly restore earlier versions of the project and in particular to establish visual comparisons or others between various states of the project simply and rapidly.
According to one embodiment of the method according to the invention a special tag exists generated automatically rather than by the user: this special tag is added when the project has not been modified by any of the client applications after a time lapse Q_{T}. Indeed, we will consider in this case, that an absence of change during a long time lapse indicates that the project is potentially in a satisfactory or stable state for the users of the method according to the invention and that this state is therefore worth preserving.

The method according to the invention therefore comprises a set of modules collaborating with one another, in the main embodiment according to an interdependent operation, built on common concepts such as for example the computation of the hash value and using the collaborative function of the invention. The method comprises in particular:
A real-time module A for synchronizing data of the project on the client applications implemented either by the server in the case of a collaborative work session (push) or by the client applications when same connect to the server (pull),
A real-time module B that from a hash value computed on the binary data of the blobs by virtue of a cryptographic encoding function, makes it possible to decide if imported blobs must be added or not to the blob store,
A real-time module C differentiating the transient state changes of the other state changes, making it possible to significantly compress the list of the creation history of the project, and reducing the impact on the amount of data stored on the storage spaces, in memory and transiting on the network,
A real-time module D using the hash key guaranteeing the integrity of the data transmitted between the client applications and the server application,
A real-time module E using in a learning algorithm (machine learning) the data of the creation history of the projects in order to hierarchize the order wherein the server application delivers within the scope of updating, the blobs to the various users and various client applications connected to the project,
A real-time module F preserving the creation history of the projects in the form of a series of total state backups of the project and of intermediate revisions relating to these states. The frequency of the backups of the total states being determined by an algorithm based on a real-time learning module (machine learning) using the data of the history,
A real-time module G making it possible for the user of the method through a user interface of the client application to mark by tags the key moments of the changes to the project and to revert back in time using or not these tags to easily restore the project in earlier states, from which comparisons between various states of the project may be presented to the user for comparative purposes.

Module for Optimizing the Management and the Process for Viewing Contents by Learning System Using Inter Alia the Data of the History.

One of the functions of the method according to the invention is to view in real time or deferred time a 3D animation content consisting of a set of drawings or clips organized in the form of sequences, as described above. The aim is to make it possible for users of the method, on the client application side, to create the most complex contents possible while maintaining the best viewing performances, that is to say with a frequency of display of the images and of the sound greater than or equal to 30 images per second for an image definition greater than or equal to the image format standard known as Full HD. In this context, the device installs a module for optimizing the process whereby the data forming the content to be viewed are transformed into animated and sound images. The collaborative use of the unified device generates significant amounts of information on 1) the use of the device itself and 2) the contents manufactured by the users of the device. This information collected by the server application comprises 1) the creation history of the project, 2) the metadata related to the use of the device and to the edition of the project 3) all of the data of which the project is constituted. The creation history has already been presented above. The metadata may include metrics such as for example the memory size necessary for the loading of a given 3D scene, the time that was needed to load this scene, the frequency of use of a given scene or asset (how many times same was edited by the users of the system, how many times the scene appears in the sequences of the final animation content), etc. The users of the device also frequently view the various scenes and sequences constituting the project: thus during these viewings, it is possible to collect information on the time for computing each image for each scene, on the use of the memory that may vary depending on what is visible on the screen, etc.

Let us emphasize that it is the collaborative and unified character of the device that makes it possible to 1) generate new information and 2) centralize same in the cloud, and that it is by virtue of this that this optimization module may be implemented. The current devices that are neither collaborative nor unified only have access to some of these data and in a non-centralized way and therefore, do not have the possibility of implementing the same method.

These data may vary depending on the client application used (same for smartphone or desktop computer for example) and on the features of the GPU and of the CPU of the system whereon the client application is executed (memory amount, number of cores, etc.). Finally it should be noted that when the final content of the project is played by the method (where the 3D scenes are displayed on the screen with the sound according to the editing information defined in the steps implemented by the method for editing sequences), the process whereby this content is computed in order to be reproduced is predictive since same is, in the most common case of use of the method, linear (as opposed to so-called interactive contents, whereof the contents change when same are played such as for example in the case of a video game). According to one embodiment of the method according to the invention, a learning (machine learning) based algorithm uses all of the information of which same disposes on the project (the creation history, the metadata collected over time by hardware configuration used, as well as the data of the project), in order to schedule and optimize the use of the resources of the system whereon the client application is executed, in order to guarantee as best as possible that the content of the project is played under the required conditions (resolution of the image, number of images per second, etc.). This module for scheduling and optimizing resources defines the part of the method according to the invention here is known as the film engine, which will subsequently be referred to under the term of movie engine. By way of example, the method during a step of collecting information has detected that a scene S3 requires 3 seconds to be loaded and 5 GB of memory on the GPU; this scene appears 10 seconds after the start of the animation sequence (a sequence Q1 consisting of 10 drawings referring to 3 different scenes S1, S2 and S3): the method is therefore capable of scheduling the loading of the scene at least 3 seconds before it is necessary to display same on the screen and that at least 5 GB of memory on the GPU is free at the time when the loading process starts, even if this means deleting from the memory data of which the method does not need immediately if necessary. Therefore, the method comprises a movie engine whereof the operation according to the main embodiment of the invention is the following:
The server application collects the following information:
   The metadata sent by the various client applications used for editing the content of the project,
   The creation history of the project
   The data of the project.
   The server processes and reorganizes this information into relevant bundles of information for the movie engine that are subsequently sent to the client applications (on the same principle as the sending of blobs),
These bundles of information provide the input data for the movie engine whereof the task is to optimize the response to the following problem: which data to load and when to load same based on the hardware configuration whereon the client application is executed, so as to guarantee a real-time uninterrupted viewing.
The movie engine refines in a substantially permanent way, and in a preferred way at a frequency greater than the frequency of the user events on the terminals, in real time, the response to this problem based on the information that is continuously sent thereto by the server application. The movie engine explores various strategies by adapting the parameters of the problem in order to optimize the response thereof in a continuous self-learning process. Thus, whereas a configuration S1 seems more efficient to a user of the system than a configuration S2, the movie engine may discover in the context of this learning process that S2 by means of modifications to specific parameters of the system is in reality more efficient than S1. For example, a strategy may consist of giving preference to the loading and the unloading of data from the storage space of the client into and from the memory of the GPU as quickly as possible rather than preserving a maximum of data in the memory of the GPU as long as possible.
The movie engine possesses alternative strategies for bypassing the limitations of the system if the scheduling process is not sufficient for guaranteeing an uninterrupted viewing. Same may according to one embodiment of the method according to the invention:
   Pre-compute before starting the viewing of the content (and install a buffer that is to say a reserved memory space) of the portions of the content before same are played, when it has been detected that in spite of all of the possible optimizations, these portions of the project cannot for example be played in real time under the required viewing conditions.
   Schedule the computation of the project at the same time on a plurality of GPUs when a single GPU is not sufficient and recompose the images computed by these GPUs in a continuous video flow.

These various options form part of the parameters that the movie engine may modify in the learning algorithm thereof in order to offer the best possible response depending on the constraints of the system (hardware configuration) and of the project.

Furthermore, the method according to the invention is a connected method. Indeed, the collaborative nature of the project requires that the version of the project that is found on the server S to which the client applications are connected, is the reference version of the project. The fact of disposing the set of data of the project (including the history thereof) on the server, makes it possible to develop a set of satellite applications that may either access the data of the project from the server, or interface directly with the client application.

These satellite applications may be considered as another type of client application.

To this end, the method according to the invention comprises a step of connecting a satellite application to the server. In a main embodiment of the invention, a software solution is executed on a smartphone or a tablet equipped with augmented reality functionality. Also by way of example, a satellite application to the server S reads the data of the project P on the server S and displays the various scenes of the project on the application of the smartphone. The user of the application may then select one of the scenes of the project, then with the aid of the augmented reality system, deposit the content of this virtual scene Sv on any surface of the real world whereof the telephone is capable of knowing the position and the orientation in the 3D space (this often concerns in the simplest case a horizontal or vertical surface, such as the surface of a table or same of a wall). The 3D virtual scene Sv is then added to the video flow coming from the camera of the telephone in double exposure. The purpose of this device is to make it possible for the user to play the 3D scene Sv and to be able to film same in augmented reality.

For this, the application proposes a recording function of the camera. When the user of the application activates this recording function, the movements of the camera in the 3D space (that are provided by the augmented reality system) and the images of the video flow created are kept in the memory of the smartphone.

Once the recording has finished, the movements of the camera, the images of the video and all of the other auxiliary data created by the augmented reality system (such as for example the so-called tracking points that are points of the real scene used by the augmented reality system to compute the position and the rotation of the smartphone in the space) are saved in the project P on the server.

This acquisition method makes it possible in particular for the user to create animated virtual cameras for a 3D animation content project by means of a general public device (smartphones or tablets).

The method implemented by computer also comprises according to one specific embodiment, a step of connecting a real-time application to the client application. In this specific embodiment, it is possible to associate a movement capture system for recording the positions and rotations of objects or of limbs of living beings (body and face), in order to control therewith a virtual counterpart on computer (camera, 3D model, or avatar). This method makes it possible to directly record the data captured on the server S in the project P; same are then immediately accessible to all of the client applications connected to the server.

These various embodiments of the invention use two connection modes, one where the satellite application accesses the data of the project P on the server S via an Internet-type network connection. The other wherein a satellite application communicates directly with a client application (by a streaming system for example) leaving the responsibility of communicating with the server to the client application in order to access the data of the project on the server.

The method according to the invention further comprises a second group of production steps referred to as dissemination steps.

These dissemination steps comprise in one embodiment a local computing and dissemination (streaming) step.

Also according to this embodiment, the user of the client application C who uses for executing this application a computer device of laptop or desktop computer type equipped with one or more central processing units (CPU) and with one or more graphics processing units (GPU) may compute the sound animated sequences on the fly (in real time), locally, by using the resources of these various processing units.

The audio and video outputs created may be redirected to any viewing device connected to the computer such as a 2D screen and loudspeakers or a virtual reality headset.

In the case of a dynamic viewing system such as for example an augmented or virtual reality system where the user of the viewing system controls the camera, the information relating to the position and the rotation of the camera provided by the viewing system are taken into account in the creation of the audio and video flow creating a feedback loop: the virtual or augmented reality system for example provides the 3D information on the position and the rotation of the real camera (of the smartphone or of the virtual reality headset) that makes it possible to compute on the computer to which same is connected the corresponding audio and video flow, these flows being themselves connected to the respective audio and video inputs of the augmented or virtual reality system.

According to a second embodiment of the invention, the computation and streaming is performed remotely from the server S.

Also in this second embodiment, the same method as same described above is used but this time the audio and video flow is computed on the server either offline or in real time.

In the offline mode, the video and audio flows may be saved in a video. In the real-time mode, the audio and video flows are computed on the fly, dynamically and are disseminated (streaming) to another electronic or computer device connected to the server by a LAN (local) or WAN (Internet for example) type network.

In this version of the invention, it is possible to compute a finalized version of the project whether in the offline or real-time form on as many processing units (CPU and GPU) as the infrastructure of the computation centre to which the server is locally connected permits (it should be noted that if the data of the project P that are on the server S are on the local network to which are also connected the processing units, the access to these data is rapid). It is also possible to use any solution for computing 3D synthesis images to create the finalized images of this content.

In the offline version, a user may adapt the speed with which a finalized version of the film is computed by increasing the number of processing units dedicated to this task.

In the real-time version, a user of the project may access remotely, computation resources much more significant that same that they have on their local computer (or the electronic device that they use for viewing the content such as a smartphone or a tablet) in order to obtain a finalized version of the real-time content of quality much superior than the version that they could obtain by using the resources of their own computer.

This last embodiment of the invention makes it possible for the computing resources (the GPU and the CPU used in the computation of the content) to be physically separated from the device for viewing this content. This device is different from the case of the dissemination of a video by streaming from a server to for example a smartphone via the Internet, where the content of the video is pre-computed. In the case of the invention, this concerns computing the content of the animation project on the fly, at the actual moment when it is disseminated (streamed) to this smartphone.

A protocol adapted to the streaming of real-time content such as for example Real-Time Streaming Protocol (RTSP) is required in this case. The content of the project is computed live, dynamically on demand. Dynamically means that the content of the project may be changed at the actual moment of the dissemination thereof (which obviously is not the case for a video). This is in particular necessary when the user of the method controls the camera as in the case of the augmented and virtual reality. This concerns the same feedback loop as same described above but in this version of the invention, the augmented or virtual reality system and the server S are connected by a LAN or WAN (Internet for example) network.

The data on the position and the rotation of the camera created by the augmented or virtual reality device are therefore sent to the server S via this network (input); this information is subsequently used to compute directly on the fly, an audio and video flow on the server S that is sent back (output) to the device by the network from where the information on the camera came.

The possibility of dynamically modifying the animation content while same is disseminated/streamed, also makes it possible to adapt the content depending for example on the preferences of each person that watches same.

In the main embodiment of the invention, it is assigned one or more processing units (hereafter named computation group) to each person watching a version of the animation content so that each computation group can create a different version of this content from the same project S. This solution is similar to the asynchronous multi-casting concept in the industry of broadcasting or streaming except that in the case described here, each audio and video flow generated and disseminated to each client connected to the streaming server is unique.

Also, it is possible to dynamically select objects of the scene as the file is viewed, in order to interact with same.

When a 3D animation film is pre-computed the information concerning the composition of the scene is lost since the pixels as already indicated above, do not have any notion of the 3D models that same represent.

This information may be saved at the pixels in the form of metadata, thus transforming same into ‘smart pixels’.

When the content of the animation project is computed on the fly, then disseminated in tight flow, all of the information on the content of the project are known since same exist on the server S. Therefore, for example the user of the method simply indicates with the aid of the mouse or of a touch screen the object that they want to select; the information on the position of the cursor on the screen is subsequently sent to the server that deduces therefrom by a set of simple computations, the 3D model that the user has selected.

It is then possible to send back thereto the supplementary information on this model or to offer same a set of services associated with this object (such as for example printing same in 3D, controlling same by Internet, etc.). It is also possible to know the entire manufacturing history of this model (who created same, who modified same, etc.)

The method according to the invention thus responds to the technical problems related to the fragmented character of non-real-time production pipelines, to the absence of collaborative solutions, and to the disconnection of the production process of the process for disseminating the 3D animation contents (whether same are real time or not).

The method according to the invention solves all of these technical problems in a global method and dedicated more particularly to the creation of real-time 3D linear animation contents for the traditional media (television and cinema) and the new media (augmented and virtual reality).

The present method according to the invention is specifically designed for the creation of linear animation contents or more generally of 3D narrative contents that may contain interactivity elements but that in any case are clearly distinguished from a video game. In this method, one or more users may in a unified process, work in real time and at the same time on any aspect of a 3D animation content (and/or mixing a variety of sound and visual sources such as for example videos, digital images, pre-recorded or procedurally generated audio sources, etc.) in simultaneous collaborative mode and remotely by using a variety of electronic and/or computer devices such as for example a smartphone, a tablet, a laptop or desktop computer, a headset or any other augmented or virtual reality system, and disseminate these contents by virtue of a variety of methods such as for example the publication of a video of the content on a video distribution platform or the streaming of a dynamic live video flow (that is to say generated on the fly, or created dynamically on demand) from a server to any interactive or not display device (virtual reality headset, smartphone or tablet screen, computer screen, etc.).

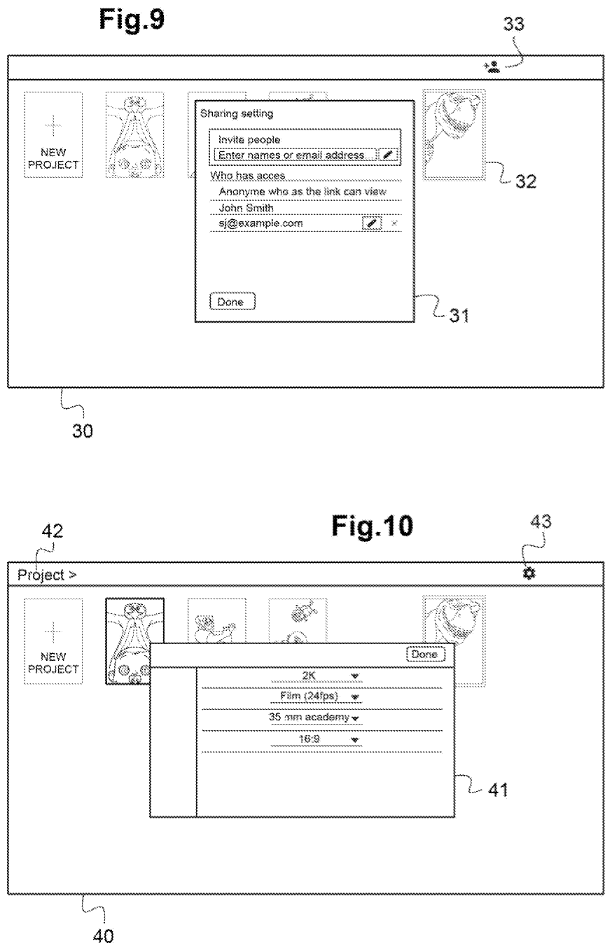

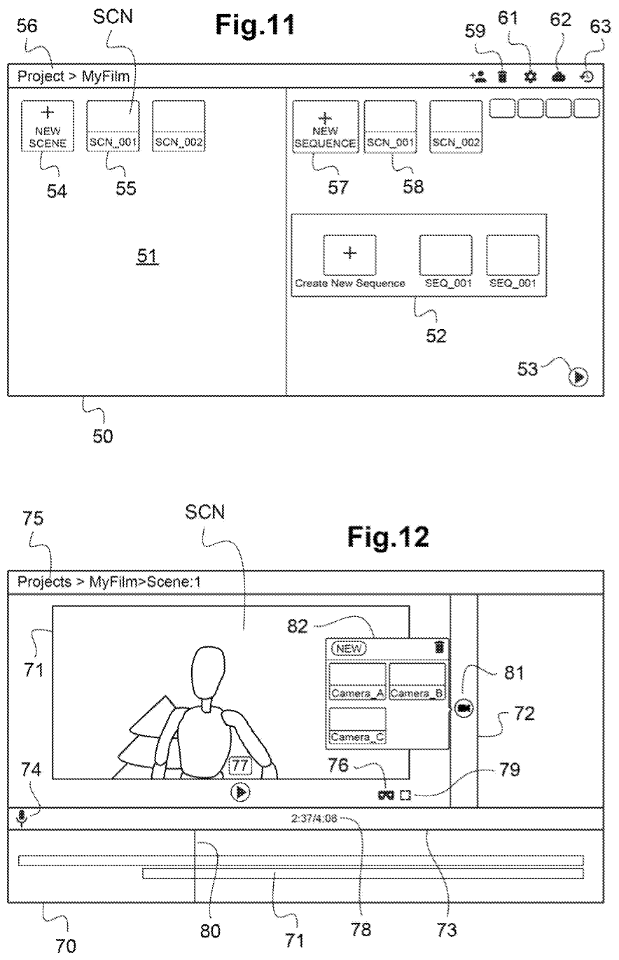

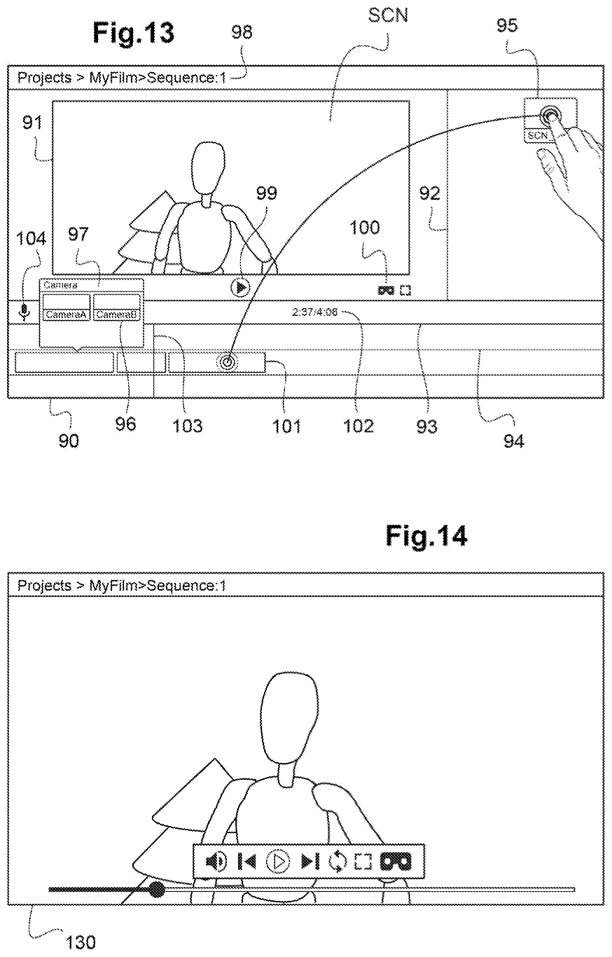

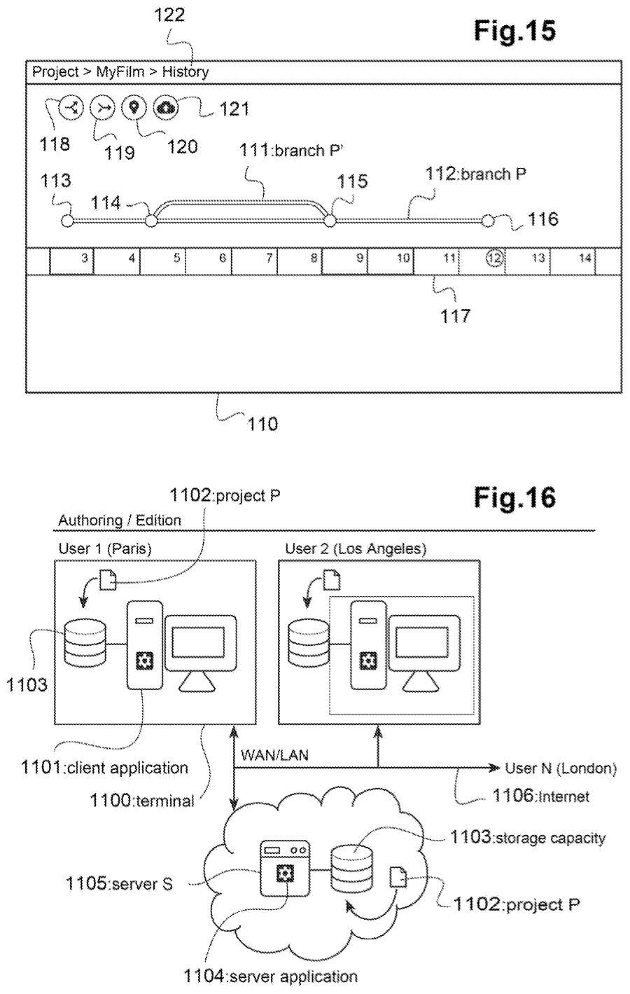

According to one detailed embodiment of the invention described with reference to FIGS. 7 to 16, the method according to the invention, in other words the collaborative unified pipeline (CUP), may be implemented on computer such as described hereafter.
1. Launching the client application: a user U1 launches the client application on a desktop computer equipped with a CPU and with a GPU. This computer (also known as terminal) is connected by a WAN-type remote network to a server located in a computation centre or a cloud platform, as shown in FIG. 16.
   In order to identify themself on the server S (whereon the server application is located), U1 must provide a username and a password, FIG. 7, validated by the server application.
2. Creating/opening a project: once connected, another screen, FIG. 8 is offered to U1 that makes it possible for them to either create a new content project or to open an existing project. The user U1 has the possibility of customizing the icon of the project P by a drag-and-drop of an image stored on the local hard drive of the computer on the icon of the project.
   In the case of an existing project, the user U1 may click once on the icon of the project P for a preview of the content of the project in the form of a small video or teaser 24 for example of thirty seconds maximum, pre-computed or computed on the fly. A double-click on the icon of the P causes same to open.
3. Creating/opening 3D virtual scenes or sound and animated sequences: the opening of the project causes the synchronization of the data on the local drive of the terminal from the server. When the local version of the project is up to date (identical in every point to the version saved on the server), another screen hereafter named the project editor is displayed, FIG. 11. Same is divided vertically into two large spaces: to the left a list of virtual 3D scenes 51 and to the right a list of sequences constituting the film 52.
   Each space includes an icon that makes it possible to create either a new scene 54 or a new sequence 57.
   The scenes and the sequences are displayed as a series of cards 55 including an image of the scene or of the sequence chosen by the user U1 or randomly (snapshot) and the name of the scene or sequence that may be edited. The scenes may be duplicated and deleted. A double-click on the card of a scene, opens the scene in edition.
4. Editing the animated scene: when the user U1 opens a scene, a new screen is presented thereto, FIG. 12. This screen (hereafter named the scene editor) proposes a workspace from which the user can edit all of the aspects of a 3D virtual scene such as for example import or model on the spot 3D models, import or create animations, import cameras or create new angle shots from which the scene may be filmed (by disposing virtual cameras in the 3D scene), import or create light sources, videos, digital images, sounds, etc.
   The scene editor presents a timeline that makes it possible for the user of the method to move in the time of the scene. The content of the scene is visible by virtue of a kind of open window on the 3D scene, computed in real time on the fly, which is called the viewport 71.
   When the user clicks on the icon of the camera in the toolbar, a window is displayed on the screen comprising the list, presented in the form of cards, of all of the cameras already created in the scene 82.
   Each card comprises the name of the camera and a small image that represents an image of the scene taken from this camera. A double-click on one of these cards makes it possible to see in the viewport, the 3D scene filmed from the camera selected.
   The camera may be animated. In order to create a new camera, it is necessary to move freely in the 3D scene, then when a viewpoint is suitable, click on the ‘new’ button of the window of the cameras 82 that has the effect 1) of adding a card to the list of cameras, 2) of creating a new camera positioned in the 3D space of the scene at the desired place.
5. Editing a visual and sound sequence: once that the user has created one or more scenes, they may come back to the project editor, FIG. 11.
   By a double-click on the card representing a sequence 58, the user opens a new screen named hereafter the sequence editor, FIG. 13. This screen makes it possible for the user to edit the content of a sequence. This screen is separated into three large sections:
      a 3D window or viewport, which is the usual terminology for the person skilled in the art, makes it possible for the user to see the result of their editing 91,
      a list of all of the 3D scenes that may be used in the editing of the sequence 92 and
      a timeline, which is the usual terminology for the person skilled in the art, that is to say the space where the user will create their editing by placing the drawings 93 end to end. The creation of a drawing on the timeline is carried out by an operation of dragging and dropping a card representing a 3D scene (hereafter SCN) from the section listing all of the 3D scenes of the project, on the timeline.
   By default, the drawing thus created on the timeline has the same duration as the duration of the SCN scene. However, this duration may be adjusted as in any editing tool.
   Finally, it is necessary once that the drawing has been created to specify the angle shot from which the 3D scene SCN must be filmed as well as the version of the animation desired for this drawing. By clicking on the drawing, such as for example in reference 101, a window is displayed on the screen 97.
   This window comprises the list of the cameras and animations of the 3D scene SCN. The user then simply chooses the camera and the version of the animation that they want to use for this drawing by clicking on the icon of the camera and of the animation representing their choice.
   Other elements such as audio sources may also be added to this timeline in order to add the sound to the image. The viewport comprises certain controls 99 that make it possible for the user to play the sequence in order to check the result of their editing.
6. Watching the sequence in virtual reality: by actuating the virtual reality function 100 in the sequence editor, it is possible to watch the sequence not only on the screen of the computer but also on a virtual reality headset connected to the computer of the user.
7. Playing the film in its entirety: by actuating the function for viewing the film, FIG. 14 from the project editor 53, the user has the possibility of playing the entire film that is to say the sequences placed end to end. The sequences are played in the same order as the order wherein same are arranged in the project editor 52.
8. Creating a virtual camera in augmented reality: the user launches a satellite application, with reference to FIG. 19, on a smartphone equipped with the augmented reality function, or with any other suitable device.
   The application connects to the server S to read therein the data of the project P 1207, 1208. The list of scenes then appears on the screen of the smartphone in the form of cards identical to same used for the project editor 1205.
   Via the touch screen of the smartphone, the user selects a scene SCN whereof they may then deposit the content on a surface of the real world in order to fix same therein. The virtual scene 3D is then filmed by the telephone as if same forming part of the real world.
   By actuating the recording function 1201, it is then possible to record the movements of the smartphone in the 3D real space while moving around the virtual scene.
   Once the recording has finished, the smartphone saves the information of the camera movement that has just been created on the server S by adding a new camera animated with the scene SCN of the project.
   This camera movement is then available in the project P in the client application from the scene editor or the sequence editor.
9. Collaborative work: another user of the method hereafter named user U2 connects to the server S by launching the client application C₂ on their own computer.
   By activating the project share function, with reference to FIG. 9, the user U1 may give the second user U2 the access to the project P.
   From that moment on, the user U2 has access to all of the data of this project and may modify the content thereof as they wish. Whenever the user U1 or the user U2 edits the content of this project, the modifications are immediately reflected or visible on the screen of the other user.
   For example, the user U1 creates a new scene from the project editor. This scene appears in the form of a new card in the interface of the two users even though it is the user U1 who modified the project. The second user U2 who therefore now also has access to this new scene decides to open same to import therein a 3D model. The model is then visible and available both in the project of the second user U2 who has just imported same but also in the project of the first user U1 who however has done nothing.
   The first user U1 decides to change the colour of this object. This colour change is also applied to the model of the project of the second user U2. This principle applies to all aspects of the project regardless of the number of users connected to the server S.
10. Managing various versions of a project by virtue of the history, with reference to FIG. 15: the users U1 and U2 may explore different versions of the same project P.
   By accessing the screen hereafter named history editor from the client application 110, the second user U2 may create a second version P′ of the project hereafter known as branch 111. All of the modifications performed by the first user U1 to the project P will no longer be visible to the second user U2 while same will be working on the project P′.
   Reciprocally, the modifications made by the second user U2 on P′ will not be visible by U1. By looking at the history editor it is possible to see that the users U1 and U2 work on two different branches, these branches being shown visually in an explicit manner, as shown in FIG. 15.
   The users U1 and U2 thus work for a while but subsequently realize that working on two versions of the project is no longer necessary. However, they want to integrate the modifications that were made to the second version of the project P′ in the project P. This operation may be performed by selecting the two branches of projects P and P′ then by carrying out a so-called merge operation, which is the dedicated term for the person skilled in the art, which consists of taking the modifications made to the second project P′ and integrating same into the main version of the project P; the two projects have been merged and the modifications made to the two projects since the creation of the branch P′ have been consolidated into one and the same version, the main version P.
   This merge operation is also shown in an explicit manner in the history editor 115.
11. Playing the film in augmented reality: a person launches a satellite application on a smartphone equipped with the augmented reality function. This person does not want to edit the content of a project but watch same, as a spectator. This application connects to the server S and provides to this spectator a list of all of the available projects. By virtue of the touch screen of the smartphone, they select a project, then select by virtue of the graphic interface provided by the augmented reality application a surface of the real world whereon the film as synthesis image will be played: such as for example the surface of a table.
12. Computing the film remotely on the server with dynamic creation of content, with reference to FIG. 18: the user U1 wants to show the result of their work on a tablet that does not, however, have the processing capacity necessary for computing same on the fly in real time. The Web page of an Internet browser makes it possible for them to see the list of available projects. Selecting one of the projects with the aid of the mouse, or of a touch screen or of any other adapted device, triggers two things:
   12.1. On the one hand an application or a service for receiving a real-time video flow; based on a RTSP-type real-time distribution protocol and for displaying same, is launched on the tablet. It may also concern the web page from which the user accesses the list of projects, since the so-called HTML5 video tag makes it possible to receive and display in a web page real-time video flows.
   12.2. On the other hand a streaming server is launched on the server S. This concerns an application that will compute a finalized version of the project on as many processing units (GPU and CPU) as desired by the user, such as parameter of the service, then disseminate/stream the result of this computation in tight flow to the tablet of the user. The content of this incoming flow will then be displayed on the screen of the tablet by virtue of the process launched in the previous step (a).

The user may interact with the content of the film watched. For example, it is possible to select an object on the screen with the aid of the mouse or of the touch screen. The object is represented as a set of pixels on the screen, but the streaming application may know the 3D model or models represented by these pixels. The 3D model selected may therefore appear on the screen surrounded by a contour (to indicate that same is selected) then an entire set of services associated with this object may be presented thereto.

By way of example in particular:
1. It is possible to customize the 3D model. Alternative versions of the model selected are proposed to the user who may choose same that they prefer. The continuous viewing of the film but with the model chosen by the user;
2. Information on what the model represents may be displayed on the screen;
3. The user may order a 3D printout of the model selected.
   The broadcaster, that is to say the service in charge of disseminating the content to the tablet, smartphone, etc. of one or more users of the service, may also modify the content of the project while same is computed and disseminated. In the case of the retransmission of a live sporting event, by way of example, it is possible to adapt the content of the animation depending on the timeliness of this event. In this case, the modifications are carried out not by the user of the service but by the operator of the service (the broadcaster). It is possible to create as many customized versions as users connected to the service.

In order to manage the collaborative work of a plurality of users U1, U2, etc., sharing the same portion of server application, in other words sharing the same set of steps of the method implemented by computer, the method also comprises steps of managing access rights. To this end, the server comprises user authentication steps. When a client application is implemented from a terminal, this application firstly connects to the server that implements the step prior to authentication.

This authentication step then assigns a digital authentication token, which comprises authentication data, hashed, encrypted or encoded according to any suitable technique known by the person skilled in the art, and access right data, which will have been previously defined in a database of the server.

In this way it is possible to make sure that a user may only act on the method for a set of production steps that are authorized thereto. Conventionally, it is possible to provide authorizations of the administrator type, giving the right to implement production steps and management steps, an authorization of the producer type, giving for example rights for the set of production steps, and targeted authorizations, for example an animator authorization only making possible the access in modification and creation at the step of animating the content produced.

The data of the animation content produced are all stored on the central server.

The data of the animation content of the assets type, such as previously defined, are stored in the form of Binary Large Objects, generally abbreviated by the acronym BLOB.

These stored data are organized in the form of data groups, known in the technical field under the name Data pool.

However, the data storage mode is not limited to this storage and referencing mode. Any other technical storage solution on server being able to be adapted to the invention.

Each data is associated to a state Rₙ on the server. This state is associated to modifications, so that in the previous state the same data was at a state Rₙ₋₁, which following a so-called Cₙ recorded modification, led the object to the state Rₙ.

The method according to the invention implements a step of managing edition and creation conflicts.

This management step is subdivided into two substeps: a step of detecting conflicts and a step of resolving conflicts.

The step of detecting conflicts is related to the history step in that same detects which concomitant actions of the history act on similar data stored in the central server.

When two, or more, edition, modification or creation actions, performed by production steps, are recorded by the history step on the server, and referring to identical, or related, data, then the step of resolving conflicts is implemented.

This step of resolving conflicts aims to give the priority to the latest modifications, creations or deletions.

Consequently, by way of example, when an object is in a state Rₙ on the server, by extension state Rₙ of the server can be mentioned for the object in question.

A first user U1 on a first terminal carries out a modification leading to change a state via an action f leading the server to a state Rₚ (that is written Rp=Rn->p), event recorded in the history.

A second user, working simultaneously on the same project and on the same object, or on a related object, commands to the server a change of state to Rf=Rn->f, also recorded in the history.

In this situation, the method for detecting conflict detects that two concomitant states are exclusive from one another.

To this end, the method then implements the step of resolving conflicts to determine which state the server must take, Rp, Rf or a different state.

As indicated the history created a time order relation between the events. In this situation, the event p is recorded as earlier than the event f.

Event p or f means the result of the implementation of a production step such as previously described.

In order to resolve this conflict, the method implements a step of determining the exclusion of the event p. Also, the event p is excluded if same meets one of the following criteria:
the event p deletes an object that has been deleted, modified, added or referenced by the event f;
the event p adds an object that has been deleted, added or modified by the event f;
the event p modifies a property of an object that has been deleted by the event f;
the event p modifies a single property of an object that has also been modified by the event f;
the event p adds a reference to an object that has been deleted by the event f;
the event p adds a reference to an object or a value for a property of an object that may have a plurality of values, that has been added, deleted or changed by the event f;
the event p deletes a reference to an object or a value of an object that may receive a plurality of values for the same property having been added, deleted or changed by the event f;
the event p moves a reference to an object or a value of a property that may receive a plurality of values having been added, deleted or moved in the same property by the event f.

If the event p enters in one of these cases it is then ignored, and the project is updated according to the last event f. Otherwise, the event p is kept with the event f.

The terminals then receive from the server an indication of update of the project, synchronizing the local data on the terminals with the state of the server according to the resolution of the conflict.

Thus, it is possible to resolve simply and effectively the edition conflicts having an impact on the method of producing contents, in real time, while ensuring that these modifications are updated directly in all of the production steps, and transmitted in real time on all of the user terminals.

The invention also relates to a computer system as shown in FIG. 16 comprising a server 1105 and one or more terminals 1100.

A terminal 1100 comprises a computer device consisting of display systems, of processing units of CPU and GPU or other type, and of storage capacity for locally saving a version of the project P 1102.

The client application 1101 according to the invention, which makes it possible to edit the content of this project is executed on this device.

The terminal is connected to the server S 1105 by a local or remote network of LAN or WAN type 1106. In the case of a WAN-type remote connection, the server is known as in the cloud. The server S itself consists of processing units (of CPU and GPU type) and of storage capacity 1103 used to save on the server a version of the project P. The server-application described in this innovation is executed on this server 1104. A plurality of terminals are connected to the server via the user 1, user 2, . . . , user N network.

FIG. 17 schematically shows the manner whereby a plurality of projects of different contents is synchronized with a plurality of different terminals.

In the first step, a modification made to the project P by a user on the terminal TA is first saved locally 1′ then disseminated to the server 1. In the second step, the server records this modification in its own version of the project 2.

In the third and last step, the server disseminates the modification to all of the terminals except for same wherefrom the modification originates 3 that in turn apply same and record same locally 3′.

At the end of this step, all of the versions of the project that exist on all of the terminals and on the server are identical, in other words the projects are synchronized.

FIG. 18 is a representation of the module whereby the content of a project may be computed on the fly and disseminated in tight flow to as many display (interactive) devices as necessary.

In the figure, three types of interactive display devices are shown: a virtual reality headset 1110 and the controllers that are associated therewith, a tablet or a smartphone equipped with augmented reality functions and with touch screens 1111, and a computer provided with a keyboard and with a mouse 1112.

The information generated by these various devices (such as for example the position of the virtual reality headset or of the smartphone in the 3D space of the real world) are sent to the server to which same are connected 1113.

These servers are different from the project server S: same are so-called streaming servers 1115.

Same are connected to the server S via a local network (LAN) which makes it possible for same to access the data of the project rapidly. One streaming server exists for each display or viewing device. This makes it possible for each streaming server equipped with its own CPU and GPU processing units, to compute a single audio and video flow 1114 that responds to the inputs of the viewing system. Each flow is therefore potentially unique.

FIG. 19 shows for its part the module making it possible for a system equipped with augmented reality functions such as a smartphone or a tablet to connect to the server S by virtue of a software solution executed on this system in order to access the data of the project such as for example, in this case, the 3D scenes of the project P.

In the example illustrated by this FIG. 19, in step 1, the 3D scenes are displayed on the screen of the smartphone in the form of cards 1205.

In step 2, the application then makes it possible to play and film these 3D scenes in augmented reality.

In step 3, once the scene has been filmed, all of the data captured by the augmented reality system such as for example the movement of the camera or the video are subsequently saved on the server S 1105.

1. Real-time and collaborative unified pipeline method implemented by computer for the creation in a collaborative manner, of animation contents, characterized in that it comprises on the one hand steps of producing and disseminating animation contents as synthesis images intended to be implemented by a plurality of terminals in cooperation with a central server, and on the other hand steps of managing these animation contents, said steps being adapted to allow the central server to centralize and manage the set of data produced at the stage of the production steps;
said steps of producing said real-time unified method comprising:
a step of creating an animation content project;
a step of creating one or more 3D scenes and one or more 3D sequences in said project created;
a step of opening and editing at least one 3D scene;
a step of opening and editing at least one 3D sequence created to assemble said content as synthesis images;
steps of disseminating the animation content;
said management steps comprising:
a step of managing a production history, adapted to provide the transmission and the recording of the result of the implementation of production steps by a terminal to the central server;
a step of updating the project stored on said server depending on said results of the implementation of production steps by a terminal transmitted during the step of managing the production history;
a step of detecting conflicts adapted to be implemented on the server so as to detect when at least two production steps have created, modified or deleted, directly or via another related data, simultaneously at least one same data stored on the central server;
a step of resolving conflicts, when a conflict is detected in the previous step, capable of determining the creation(s), modification(s) or deletion(s) to apply to said at least one data for which a conflict is detected.

2. Method implemented by computer according to claim 1, characterized in that it comprises a step of real-time synchronization of the project between the central server and said terminals so that each terminal implementing the production steps of the method receive all or part of the data of the project up to date depending on all of the modifications and creations made by the set of the terminals and of the server, said synchronization step being adapted to be implemented by the server during an operation in collaborative work mode and/or by said terminals when same are connected to the server.

3. Method implemented by computer according to claim 2, characterized in that it comprises for said steps of updating and of synchronizing the project between the central server and said terminals a plurality of data synchronization modules, said plurality of modules comprising:
a real-time update module adapted to implement a cryptographic encoding function generating a hash key depending on said data of the project, said real-time update module being adapted to determine if the data of the project imported must be recorded by said terminals and the server;
a real-time optimization module capable of detecting changes in transient state of the data of the project, and being adapted to compress said list of the creation history of projects so as to reduce the amount of data transferred and stored by said terminals and the server;
a real-time control module using said hash key so as to control the integrity of the data transmitted between said terminals and the server,
a real-time learning module, capable of analyzing the data of the creation history of projects, and of defining an order of priority, according to which said server transmits and updates, the data to said terminals;
a real-time versioning module, capable of preserving the creation history of projects in the form of a series of total state backups of the project and of intermediate revisions relative to these states; said frequency of the backups of the total states depending on learning data of said real-time learning module;
a real-time marking module capable of authorizing a user of a terminal to mark by at least one tag a key step of the development of the project, said marking module making it possible to restore said project to the state thereof at the moment of marking.

4. Method implemented by computer according to any one of claims 1 to 3, characterized in that it further comprises access management steps for prohibiting or permitting the implementation or all or part of the production and management steps to a terminal connected to the server.

5. Method implemented by computer according to any one of claims 1 to 4, characterized in that:
the step of resolving conflicts comprises the exclusion from the project of a first result of the implementation of production steps by a first terminal, when a second result of the implementation of production steps by a second terminal has generated the detection of a conflict, the earlier event being excluded if one of the following criteria is met:
the first result deletes an object that has been deleted, modified, added or referenced by the second result;
the first result adds an object that has been deleted, added or modified by the second result;
the first result modifies a property of an object that has been deleted by the second result;
the first result modifies a single property of an object that has also been modified by the second result;
the first result adds a reference to an object that has been deleted by the second result;
the first result adds a reference to an object or a value for a property of an object that may have a plurality of values, which has been added, deleted or changed by the second result;
the first result deletes a reference to an object or a value of an object that may receive a plurality of values for the same property having been added, deleted or changed by the second result;
the first result moves a reference to an object or a value of a property that may receive a plurality of values having been added, deleted or moved in the same property by the second result.

6. Method implemented by computer according to any one of claims 1 to 5, characterized in that it comprises an automatic learning module adapted to optimize the sequence for loading data into the memory of said terminals in order to reproduce as sound and animated images the content of the project in real time on said terminals, depending on the data of the project creation history, data of the project and metadata generated by said terminals.

7. Method implemented by computer according to any one of claims 1 to 6, said steps of producing and disseminating the animation content, comprise a step of displaying in real time said animation content on an augmented reality device, such as a smartphone or a tablet, connected to said server.

8. Server device comprising a network interface, a storage memory and a processor for implementing at least the steps of managing and/or the steps of disseminating and distributing the animation content of the method according to any one of claims 1 to 7.

9. Augmented reality assembly, comprising a server device according to claim 8 and an augmented reality device, such as a smartphone or a tablet, said server device implementing the steps of producing and disseminating the animation content of the method according to claim 7.

10. Computer terminal for controlling a human-machine interface adapted to execute and/or perform at least the production steps of the method according to any one of claims 1 to 7, and comprising a network interface for communicating with said server device according to claim 8 or 9.

11. Computer system comprising a server device according to claim 8 or 9 and one or more computer terminals according to claim 10.

12. Storage medium readable by a computer having recorded thereon instructions that control a server device and/or a computer terminal for executing a method according to any one of claims 1 to 7.
